(19) United States
(12) Patent Application Publication
(10) Pub. No.: US 2015/0302998 A1
(43) Pub. Date: Oct. 22, 2015

(54) Hybrid Supercharged Ultra Cell Technology to replaced Non Environmental Friendly Lead Acid Battery

(71) Applicant: Kok Onn Lo, Penang (MY)

(72) Inventor: Kok Onn Lo, Penang (MY)

(21) Appl. No.: 14/256,932

(22) Filed: Apr. 19, 2014

(51) Int. Cl. H01G 11/10; H01G 11/32

(52) U.S. Cl. CPC H01G 11/10; H01G 11/32

(57) ABSTRACT

This article discloses the Innovation of a Hybrid Supercharged Ultra Cell System where the Charging and Discharging Process is managed by the Energy Management Controller Hardware that can Charged and Discharged from the Graphene based Ultra Capacitors Bank at tremendous speed and Coupled with Lithium Buffer Energy Reservoir can power up Automobiles [Gas Engine Vehicle, Hybrid or Electric Vehicle], Solar Power Applications and other portable Power Storage Medium

### BACKGROUND OF THE INVENTION

The need for a replacement of Toxic Non Environmental friendly Lead Acid Battery is escalating and is greatly in demand especially the Global market in moving towards GREEN Energy Environmental Concept.

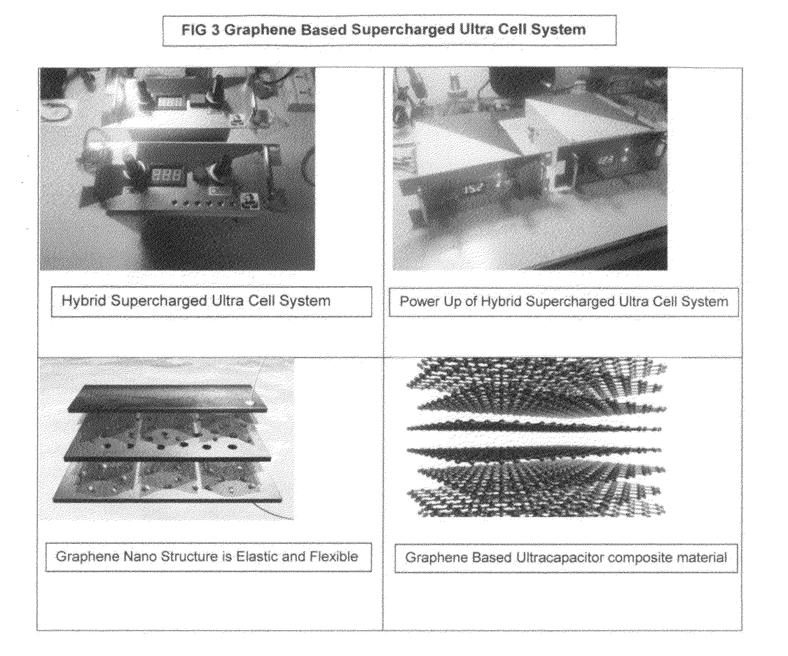

This Innovation of Hybrid Supercharged Ultra Cell system [Refer: FIG. 3] is to utilized Graphene Based Supercapacitor, where the Charging and Discharging Process is managed by the Energy Management Controller Hardware, as an Immediate Main Energy Peripheral Discharge Interface, due to its extremely low resistivity properties, to discharge onto any external load and the Lithium Phosphate Medium as a Buffer Energy Storage to top up the Graphene Based Supercapacitor which has rapid charging capabilities.

A capacitor is an energy storage medium similar to an electrochemical battery. Supercapacitors, also known as Ultracapacitors are therefore suitable as a replacement for electrochemical batteries in many industrial and commercial applications but must be managed precisely on the Charging and Discharging Process by the Energy Management Controller Hardware which this Innovation evolves.

This Hybrid Supercharged Ultra Cell System design also work in very low temperatures; a situation that can prevent many types of electrochemical batteries from working. The development of Graphene-Based Ultracapacitor [Refer: FIG. 3], in this Innovation design, has high porosity with massive internal surface area due to its nanostructure properties. Graphene is essentially just graphite, which is a form of carbon, it is ecologically friendly, unlike most other forms of energy storage.

Graphene is, basically, a single atomic layer of graphite; an abundant mineral which is an allotrope of carbon that is made up of very tightly bonded carbon atoms organised into a hexagonal lattice. What makes graphene so special is its sp2 hybridisation and very thin atomic thickness (of 0.345 Nm). These properties are what enable graphene to break so many records in terms of strength, electricity and heat conduction

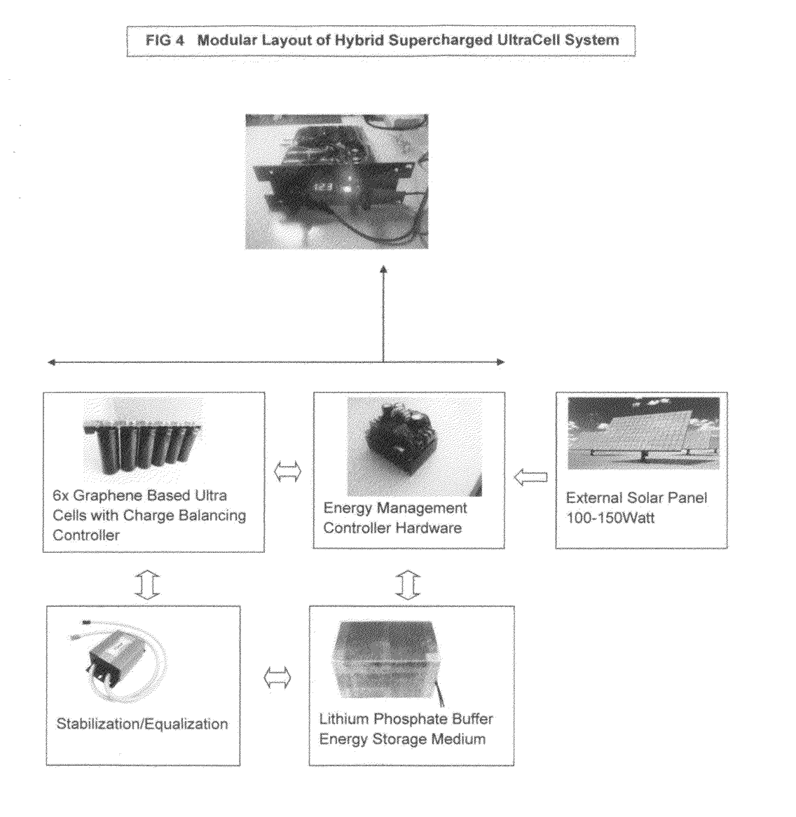

The Hybrid Supercharged Ultra Cell System [Refer: FIG. 4] comprises of the 6× Graphene Based Ultra Capacitors as an Immediate Main Energy Peripheral Discharge Interface, 1× Lithium Phosphate Buffer Energy Storage Medium, 1× Energy Management Controller Hardware, 1× Stabilization/Equalization Controller and 1× Charge Balancing Controller.

### BRIEF SUMMARY OF THE INVENTION

The Hybrid Supercharged Ultra Cell System has high Energy Storage capability due to its high porosity of Graphene Nanostructure to achieve a high surface area for high energy density storage.

The Hybrid Supercharged Ultra Cell System has low Equivalent Series Resistance providing fast Charge and Discharge features through the absorption and release of the ion composition.

Also the Hybrid Supercharged Ultra Cell System has Low temperature Operation and is capable of delivering energy down to −40 C with minimum effect on efficiency.

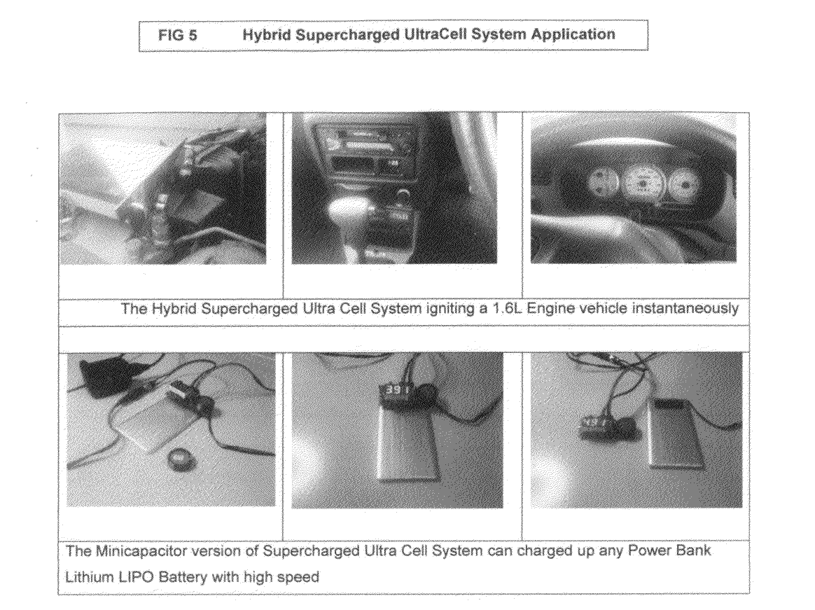

The Hybrid Supercharged Ultra Cell System [Refer: FIG. 5] can be powered up by Solar Panel or by the Vehicle Alternator and can power up any Gas Engine Vehicle, Hybrid Vehicle and Electric Vehicle replacing the conventional Non Environmental Friendly Lead Acid Battery completely or Lithium Ion Battery in Hybrid/Electric Vehicle.

The Supercharged Ultra Cell System [Refer: FIG. 5] also can be Miniaturized to power up Power Bank Lithium LIPO Battery of any Handphone, IPAD, IPOD and Laptop with Fast Charging Features in secs [Present Conventional Lithium LIPO Power Bank takes 1 hr-1.5 hrs charging time]

### DETAILED DESCRIPTION OF THE INVENTION

The Hybrid Supercharged Ultra Cell System comprises of the 6× Graphene Based Ultra Capacitors which is interfaced to the Energy Management Controller Hardware which control the Charging and Discharging rate of the Ultra Capacitors and is further synchronized with the Stabilization/Equalization Controller for voltage stabilization of the overall energy distribution. The Energy Management Controller Hardware also interfaces with the Power Balancing Controller, of the Graphene Based Ultra Capacitors, and it suppressed any overcharging of the Ultra capacitors.

The Stabilization Controller basically works as a damper for noise voltage which comes from the alternator/generator/magneto and ignition system (CDI, etc), hence improving the performance (Power to Torque ratio), the lighting system of the vehicle, Improving the quality of the sound system, Extend the life of the Ultra Cell System and Lithium Phosphate Storage Medium and also enable fuel savings.

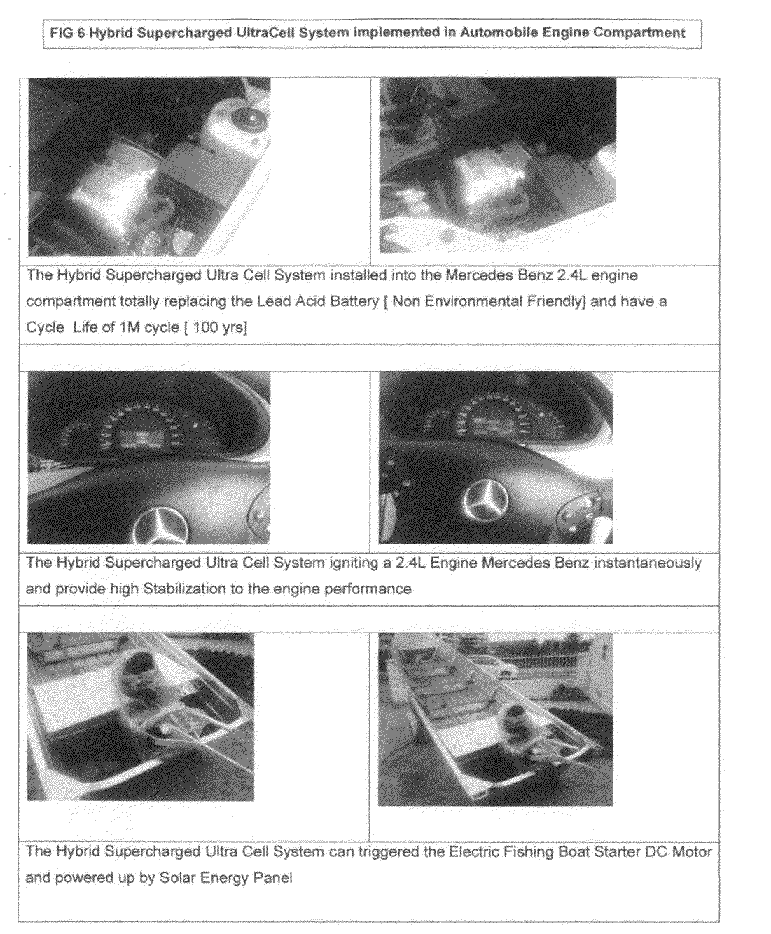

When the Hybrid Supercharged Ultra Cell System [Refer: FIG. 6] is fitted into the Battery Compartment of the vehicle Combustion Engine, replacing the Lead Acid Battery completely, the vehicle engine [2.0 L-2.5 L capacity of Mercedes Benz] can easily be ignited and the vehicle can received instantaneous BOOST of Energy delivered by the Graphene Based Supercharged Ultra Cell and the driver will feel the immediate sensation of the high acceleration response and performance efficiency of the vehicle. Also there will be an increase in the engine output torque and the sensitivity of shift gearing. The System also improves the vehicle ignition efficiency and lessens fuel consumption (over 10%). The Stabilization Controller installed in the system enhances the current output and reduces the engine vibration due to Sparkplug complete combustion. The Supercharged Ultra Cell System increases the sensitivity and accuracy of signals of the vehicle ECU and sensors and optimizes the fuel consumption, the output power and the vehicle handling safety.

### DESCRIPTION OF THE TECHNICAL DRAWING SPECIFICATION

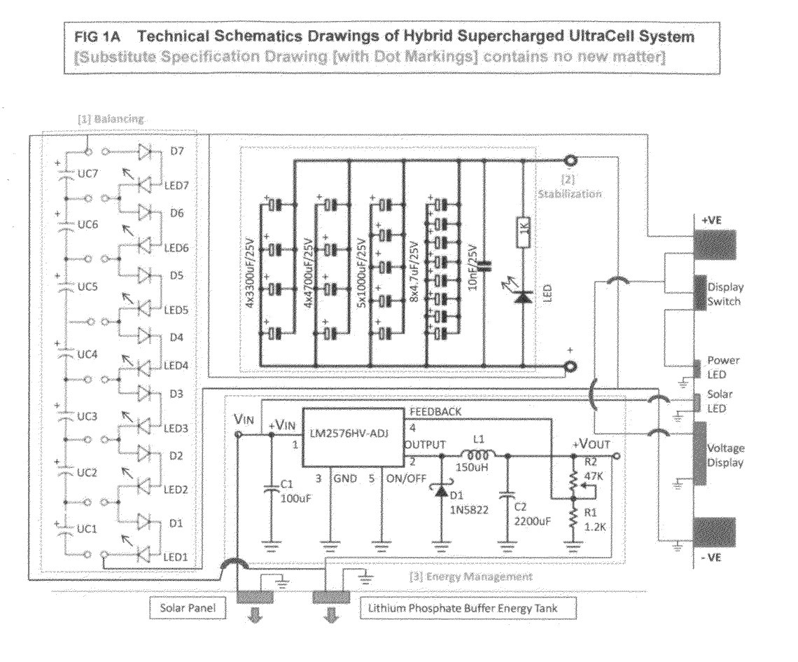

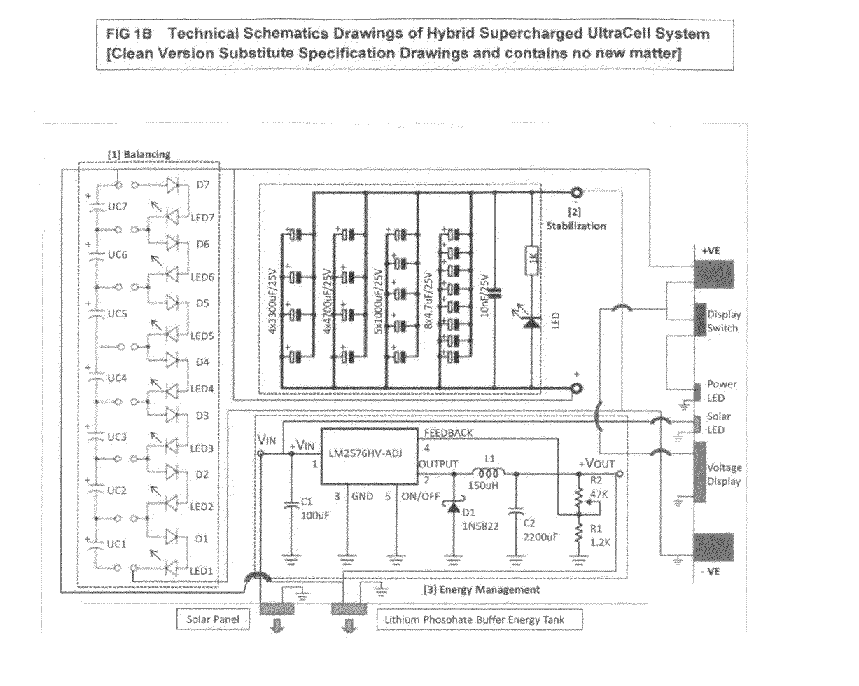

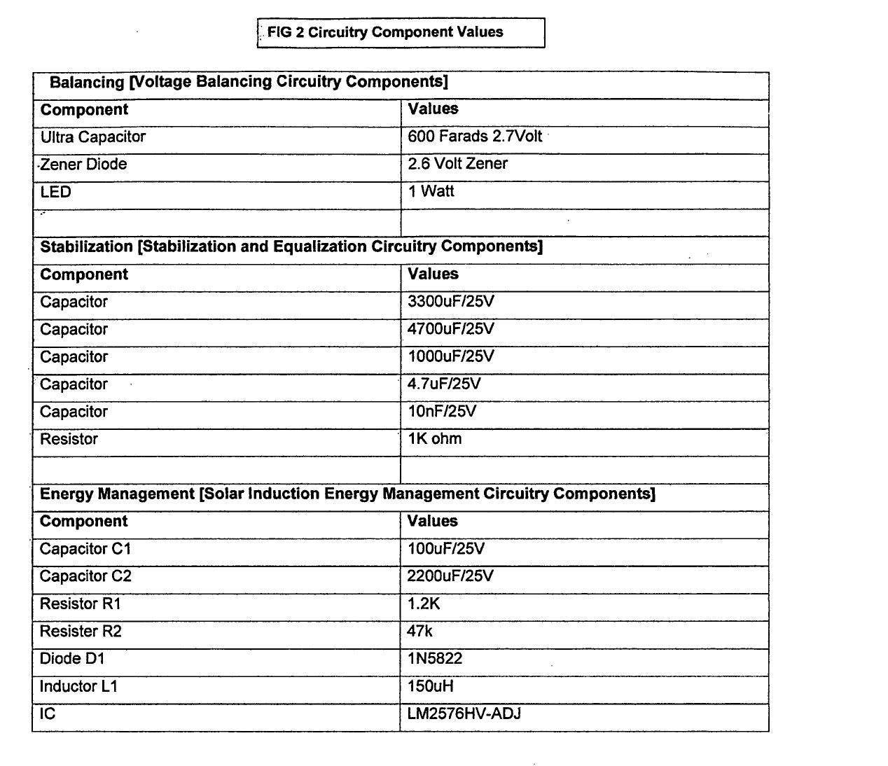

### Technical Drawing Specification [Refer: FIG. 1A/1B and FIG. 2]

The Technical Drawing Specification depicts the Hybrid Supercharged UltraCell Schematics which comprises a Voltage Balancing Circuitry, Stabilization Circuitry and the Solar Induction Energy Management Circuitry
[1] Balancing [Marked Dot Line] [Voltage Balancing Circuitry]: Wiring a LED and Zener Diode in series between each Ultra Capacitor [Ultra Capacitor 2.7 Volt Max] as indicated in FIG. 1 will cause any voltage above 2.7V to dump through the Zener diode and LED causing the LED to light up and causing the Ultra Capacitor to be drained until it reaches 2.7V. While charging, once all the LED's light up, it is an indication that all the Ultra Capacitors are fully Charged up and Balanced.
[2] Stabilization [Marked Dot Line] [Stabilization and Equalization Circuitry]: This Stabilization Circuitry works as a Damper Noise Voltage suppression, wherein each customized capacitor is selected to reduce the amount of noise that is different. The smaller the value of its capacitance, the higher the frequency to be suppressed from the electrical system. Generally defects/noise voltage comes from the automobile alternator/generator/magneto and ignition system [CD, etc] that needs to be improved in order to provide good power quality.
[3] Energy Management [Marked Dot Line] [Solar Induction Energy Management Circuitry]: The LM2577 acts as an Energy Booster, Flyback and Forward Converter Switching Regulator and has a wide Input Voltage range of 3.5V to 40V and has adjustable Output Voltage Range. The chip includes a 3A NPN switching transistor to provide associated protection circuitry, consisting of current and thermal limiting and under voltage lockout. Also the LM2577 has a 52 kHz fixed frequency internal oscillator that requires no external components, soft start mode to reduce in-rush current during start-up and current mode control for improved rejection of input voltage and output load transients. By selecting different values for R1 and R2, the LM2577 can trigger different output voltages for efficient Energy Management of the solar charging of the Ultra Capacitors and Lithium Phosphate Reservoir Tank as the Solar Panel Energy fluctuates throughout the day. The Output Voltage is governed by the formula:

Vout=1.23[1+R1/R2]

### REFERENCES

[1] R. Kotz and M. Carlen, “Principles and Applications of Electrochemical Capacitors,” Electrochimica Acta, Vol. 45, No. 15, 2000, pp. 2483-2498.
[2] B. E. Conway, “Electrochemical Supercapacitors: Scientific Fundamentals and Technological Applications,” Springer, Berlin, 1999. doi:10.1007/978-1-4757-3058-6
[3] G. Wang, L. Zhang and J. Zhang, “A Review of Electrode Materials for Electrochemical Supercapacitors,” Chemical Society Reviews, Vol. 41, No. 2, 2012, pp. 797-828. doi:10.1039/c1cs15060j
[4] I. H. Kim and K.-B. Kim, “Ruthenium Oxide Thin Film Electrodes for Supercapacitors,” Electrochemical and Solid-State Letters, Vol. 4, No. 5, 2001, pp. A62-A64. doi:10.1149/1.1359956
[5] G. Arabale, D. Wagh, M. Kulkarni, I. Mulla, S. Vernekar, K. Vijayamohanan and A. Rao, “Enhanced Supercapacitance of Multiwalled Carbon Nanotubes Functionalized with Ruthenium Oxide,” Chemical Physics Letters, Vol. 376, No. 1-2, 2003, pp. 207-213.
[6] Z. Algharaibeh, X. Liu and P. G. Pickup, “An Asymmetric Anthraquinone-Modified Carbon/Ruthenium Oxide Supercapacitor,” Journal of Power Sources, Vol. 187, No. 2, 2009, pp. 640-643. doi:10.1016/j.jpowsour.2008.11.012
[7] E. Frackowiaka and F. Beguinb, “Carbon Materials for the Electrochemical Storage of Energy in Capacitors,” Carbon, Vol. 39, No. 6, 2001, pp. 937-950. doi:10.1016/S0008-6223(00)00183-4
[8] H. Pan, J. Li and Y. Feng, “Carbon Nanotubes for Supercapacitor,” Nanoscale Research Letters, Vol. 5, No. 3, 2010, pp. 654-668. doi:10.1007/s11671-009-9508-2
[9] Y. Huang, J. Liang and Y. Chen, “An Overview of the Applications of Graphene-Based Materials in Supercapacitors,” Small, Vol. 8, No. 12, 2012, pp. 1805-1834. doi:10.1002/sm11.201102635
[10] L. Yuan, X.-H. Lu, X. Xiao, T. Zhai, J. Dai, F. Zhang, et al., “Flexible Solid-State Supercapacitors Based on Carbon Nanoparticles/MnO2 Nanorods Hybrid Structure,” ACS Nano, Vol. 6, No. 1, 2012, pp. 656-661. doi:10.1021/nn2041279
[11] M. Hughes, G. Z. Chen, M. S. P. Shaffer, D. J. Fray and A. H. Windle, “Electrochemical Capacitance of a Nanoporous Composite of Carbon Nanotubes and Polypyrrole,” Chemistry of Materials, Vol. 14, No. 4, 2002, pp. 1610-1613. doi:10.1021/cm010744r
[12] K. Zhang, L. L. Zhang, X. S. Zhao and J. Wu, “Graphene/Polyaniline Nanofiber Composites as Supercapacitor Electrodes,” Chemistry of Materials, Vol. 22, No. 4, 2010, pp. 1392-1401. doi:10.1021/cm902876u
[13] H. Wang, Q. Hao, X. Yang, L. Lu and X. Wang, “A Nanostructured Graphene/Polyaniline Hybrid Material for Supercapacitors,” Nanoscale, Vol. 2, No. 10, 2010, p. 2164. doi:10.1039/c0nr00224k
[14] S. Bose, N. H. Kim, T. Kuila, K. Lau and J. H. Lee, “Electrochemical Performance of a Graphene-Polypyrrole Nanocomposite as a Supercapacitor Electrode,” Nano-Technology, Vol. 22, No. 29, 2011, Article ID: 295202. doi:10.1088/0957-4484/22/29/295202
[15] Q. Wu, Y. Xu, Z. Yao, A. Liu and G. Shi, “Supercapacitors Based on Flexible Graphene/Polyaniline Nanofiber Composite Films,” ACS Nano, Vol. 4, No. 4, 2010, pp. 1963-1970. doi:10.1021/nn1000035
[16] H. Gomez, M. K. Ram, F. Alvi, P. Villalba, E. (Lee) Stefanakos and A. Kumar, “Graphene-Conducting Polymer Nanocomposite as Novel Electrode for Supercapacitors,” Journal of Power Sources, Vol. 196, No. 8, 2011, pp. 4102-4108. doi:10.1016/j.jpowsour.2010.11.002
[17] F. Alvi, M. K. Ram, P. A. Basnayaka, E. Stefanakos, Y. Goswami and A. Kumar, “Graphene polyethylene dioxythiophene Conducting Polymer Nanocomposite Based Supercapacitor,” Electrochimica Acta, Vol. 56, No. 25, 2011, pp. 9406-9412.
[18] F. Alvi, P. A. Basnayaka, M. K. Ram, H. Gomez, E. Stefanako, Y. Goswami and A. Kumar, “Graphene-Polythiophene Nanocomposite as Novel Supercapacitor Electrode Material,” Journal of New Materials for Electrochemical Systems, Vol. 15, No. 2, 2012, pp. 89-95.
[19] F. Alvi, M. K. Ram, P. Basnayaka, E. Stefanakos, A. Hoff and A. Kumar, “Novel Graphene-Conducting Polythiophenes Materials for Applications in the Electrochemical Supercapacitors,” ECS Meeting, Vol. 1, No. 11, 2011, p. 596.
[20] D. Zhang, X. Zhang, Y. Chen, P. Yu, C. Wang and Y. Ma, “Enhanced Capacitance and Rate Capability of Grphene/Polypyrrole Composite as Electrode Material for Supercapacitors,” Journal of Power Sources, Vol. 196, No. 14, 2011, pp. 5990-5996. doi:10.1016/j.jpowsour.2011.02.090
[21] S. Biswas and L. T. Drzal, “Multilayered Nanoarchitecture of Graphene Nanosheets and Polypyrrole Nanowires for High Performance Supercapacitor Electrodes,” Chemistry of Materials, Vol. 22, No. 20, 2010, pp. 5667-5671. doi:10.1021/cm101132g
[22] C. Niu, E. K. Sichel, R. Hoch, D. Moy and H. Tennent, “High Power Electrochemical Capacitors Based on Carbon Nanotube Electrodes,” Applied Physics Letters, Vol. 70, No. 11, 1997, pp. 1480-1482. doi:10.1063/1.118568
[23] P. L. Taberna, P. Simon and J. F. Fauvarque, “Electrochemical Characteristics and Impedance Spectroscopy Studies of Carbon-Carbon Supercapacitors,” Journal of the Electrochemical Society, Vol. 150, No. 3, 2003, pp. A292-A300. doi:10.1149/1.1543948
[24] J. Gamby, P. Taberna, P. Simon and J. F. Fauvarque, “Studies and Characterization of Various Activated Carbons Used for Carbon/Carbon Supercapacitors,” Journal of Power Sources, Vol. 101, No. 1, 2001, pp. 109-116.
[25] Y. Zhu, S. Murali, M. D. Stoller, K. J. Ganesh, W. Cai, P. J. Ferreira, A. Pirkle, R. M. Wallace, K. A. Cychosz, M. Thommes, D. Su, E. A. Stach and R. S. Ruoff, “Carbon-Based Supercapacitors Produced by Activation of Graphene,” Science, Vol. 332, No. 6037, 2011, pp. 1537-1541. doi:10.1126/science.1200770
[26] V. V. Karambelkar and J. D. Ekhe, “High Yield Polypyrrole: A Novel Approach to Synthesis and Characterization,” Journal of Material Science, Vol. 46, No. 16, 2011, pp. 5324-5331. doi:10.1007/s10853-011-5470-3
[27] A. C. Ferrari, J. C. Meyer, V. Scardaci, C. Casiraghi, M. Lazzeri, F. Mauri, S. Piscanec, D. Jiang, K. S. Novoselov, S. Roth and A. K. Geim, “Raman Spectrum of Graphene and Graphene Layers,” Physical Review Letters, Vol. 97, No. 18, 2006, Article ID: 187401. doi:10.1103/PhysRevLett.97.187401
[28] V. Daniel, “Dielectric Relaxation,” Academic Press, London and New York, 1967.
[29] Héctor D. Abruña, Yasuyuki Kiya, Jay C. Henderson (2008), “Batteries and electrochemical capacitors” (in German), Physics Today (12): pp. 43-47, https://ecee.colorado.edu/˜ecen4555/SourceMaterial/ElectricalEnerStor1208.pdf
[30] J. O'M. Bockris, M. A. V. Devanathan and K. Muller (1963), “On the Structure of Charged Interfaces” (in German), Proceedings of the Royal Society 274 (1356): pp. 55-79, doi:10.1098/rspa.1963.0114
[31] F. Béguin, E. Raymundo-Piñero, E. Frackowiak, Carbons for Electrochemical Energy Storage and Conversion Systems, Chapter 8. Electrical Double-Layer Capacitors and Pseudocapacitors, CRC Press 2009, Pages 329-375, Print ISBN 978-1-4200-5307-4, eBook ISBN 978-1-4200-5540-5^{[189]}
[32] B. E. Conway, Electrochemical Supercapacitors: Scientific Fundamentals and Technological Applications, Springer, ISBN=0306457369, 1999, Online=[10], p. 1, at Google Books
[33] Jiujun Zhang, Lei Zhang, Hansan Liu, Andy Sun, Ru-Shi Liu (2011) (in German), [[11], p. 317, at Google Books Electrochemical Technologies for Energy Storage and Conversion, Band 1], Weinheim: Wiley-VCH, pp. 317-376, ISBN 978-3-527-32869-7, [12], p. 317, at Google Books

What claimed is:

1. The Hybrid Supercharged Ultra Cell System has FAST Charge/Discharge features through the absorption and release of ions and coupled with its low Equivalent Series Resistance [ESR].

2. The Hybrid Supercharged Ultra Cell System can operate at Low Temperature delivering Energy down to −40 C with minimal effect on efficiency

3. The Hybrid Supercharged Ultra Cell System has unlimited Discharge Cycles of greater than 500,000 Cycle Life compared to Lead Acid Battery which has a Life Cycle of only 1,000 Cycle.
